(19) United States
(12) Patent Application Publication
(10) Pub. No.: US 2008/0013169 A1
(43) Pub. Date: Jan. 17, 2008

(54) Illumination System For A Microscope

(75) Inventors: Juha Korpinen, Nokia (FI); Jussi Tarvainen, Tampere (FI)

Correspondence Address: VENABLE LLP, P.O. BOX 34385, WASHINGTON, DC, 20043-9998, US

(73) Assignee: Chip-Man Technolgies Oy, Tampere (FI)

(21) Appl. No.: 11/628,989

(22) PCT Filed: Jul. 8, 2005
(86) PCT No.: PCT/FI05/50275

§ 371 Date: Dec. 8, 2006

(30) Foreign Application Priority Data
Jul. 9, 2004 (FI) 20040969

(51) Int. Cl. G02B 21/06

(52) U.S. Cl. 359/385

(57) ABSTRACT

An automatic microscope apparatus intended to be used in the phase contrast imaging of living cells. The apparatus includes a sample plate station in which a sample plate containing a sample to be examined can be fitted, as well as a microscope. The microscope includes an optical element, an imager and an illumination arrangement that can be arranged to illuminate the sample. The illumination arrangement includes an LED illuminator to provide illumination.

### FIELD OF THE INVENTION

The invention relates to a microscope apparatus according to the preamble of the appended claim 1. Furthermore, the invention relates to the use of an illuminating component according to the appended claim 6.

### BACKGROUND OF THE INVENTION

Cell culturing is generally used e.g. in various cell biological and biomedical analyses. Typically, the cell material to be analyzed is cultured in a Petri dish or on a well plate placed in suitable conditions with respect to the temperature, ambient gas and illumination. At various stages of the analyses, the samples are subjected to, for example, microscopy, and in arrangements of prior art, the well plate is arranged to be examined with a microscope which may be equipped with a camera. In many studies, the same samples are examined at regular intervals so that the development of the cell can be monitored. For the research, however, it is problematic that the cells to be cultured under dark conditions must be exposed to light during the imaging. The cells are then exposed to external energy which may have a positive or negative effect on the state of the cells, depending on the duration of exposure, the intensity and the wavelength of the radiation. Various solutions have been developed to relieve this problem.

Patent application publication WO 03/048705 discloses an automatic microscope system in which the time of exposure of cells to light has been shortened by using quick automatic focusing. The system is suitable for both phase contrast imaging and fluorescence imaging. In said arrangement, an image is taken by using, as the light source, Xenon light with high intensity and a wide spectrum. If it is necessary for the imaging to filter off some wavelengths of light, it is done by using a filter structure in connection with the imaging optics. The energy of the wide-spectrum Xenon light, to which the cells are exposed, is very difficult to control, and furthermore, it takes some time for the lighting level of Xenon light to stabilize. For this reason, it is possible that when Xenon light is used, cells are exposed to too much light in terms of either the total quantity or the maximum intensity of light energy. On the other hand, if a filter is used to cut off a narrow wavelength band from wide-spectrum light, a high total output of the light source is required.

### SUMMARY OF THE INVENTION

Now, a solution has been invented which makes it possible to illuminate an object briefly and precisely so that the exposure of living cells to be examined to radiation can be substantially reduced in comparison with Xenon lighting.

To attain this purpose, the microscope apparatus according to the invention is primarily characterized in what will be presented in the characterizing part of the independent claim 1. The use according to the invention, in turn, is primarily characterized in what will be presented in the independent claim 6. The other, dependent claims will present some preferred embodiments of the invention.

The basic idea of the invention is that the light required for imaging a living object is produced for the object only when the object is being imaged, and furthermore, the spectrum of the light used is kept narrow. During the relative movement of the imaging apparatus and the object to be imaged, no light is directed to the object. According to an advantageous embodiment of the invention, the illumination is provided by using LED (Light Emitting Diode) technology in which the functional mode is achieved very quickly and the range of emission is known with a substantial accuracy.

When the time of exposure and the spectrum of light used for the illumination are limited as well as possible, the cells are exposed to a minimum of radiation. The LED achieves its stable functional mode significantly faster than Xenon, for example. Consequently, illumination by LED can be turned on accurately for the time necessary for the imaging only, wherein the cells are not exposed to extra light. In other words, the energy of the radiation to which the cells are exposed can be controlled better, and this, in turn, has a positive effect on the overall result of the examination.

Furthermore, the light emitted by the LED is almost monochromatic, wherein the light does not cause significant chromatic distortions and the quality of the image is thus significantly improved when compared to the use of wide-spectrum light. By means of the illumination system according to the invention, it is possible to form images of high fidelity without the use of bandpass filters.

One embodiment of the invention has the advantage that the wavelength can be selected according to the need. In one embodiment, use is made of a LED which can operate at several different wavelengths. The use of several wavelengths makes it possible to take sharp multilayer images of the object easily, because the different wavelengths are focused at different distances. At present, a high-quality bandpass filter is about one decade more expensive than an efficient LED, and only one wavelength band can be separated by one component. By the above-mentioned LED, the wavelength of the light can be changed without the mechanical changing of a filter, which, for its part, makes it possible to take images fast at different wavelengths.

The invention is very advantageous when the phase contrast method is used. In one embodiment of the invention, the illumination is directed to the object from above, and the light passes via the sample and a tube microscope, used as the microscope, to a camera.

### DESCRIPTION OF THE DRAWINGS

In the following, the invention will be described in more detail with reference to the appended skeleton drawings, in which

FIG. 1 shows a microscope apparatus according to the invention,

FIG. 2 shows a detail in the microscope apparatus,

FIG. 3 shows one embodiment of an illumination arrangement,

FIGS. 4 and 5 show details in the illumination arrangement, and

FIG. 6 shows the path of light according to one embodiment of the illumination arrangement.

For the sake of clarity, the figures only show the details necessary for understanding the invention. The structures and details that are not necessary for understanding the invention but are obvious for anyone skilled in the art have been omitted from the figures to emphasize the characteristics of the invention.

### DETAILED DESCRIPTION OF THE INVENTION

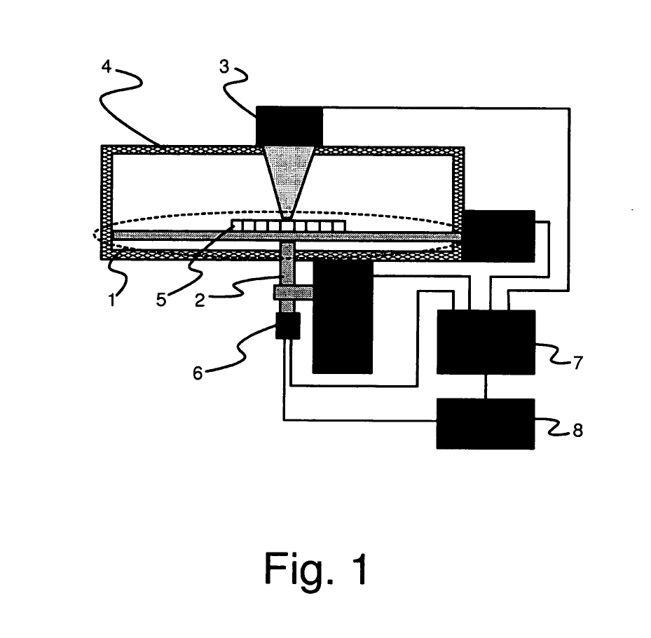

FIG. 1 shows an apparatus which is suitable, for example, for the culturing and examining of living cells. The apparatus comprises e.g. a well plate station 1, a phase contrast tube microscope 2, and an illuminating device 3. Furthermore, the figure shows a shield structure 4 providing the well plate 5 with a space whose illumination and temperature are controllable. Typically, living cells are preferably kept in the dark at the temperature of 36 to 37 degrees. Furthermore, it is often advantageous to control the composition of the ambient gas around the cells, for example by controlling the content of carbon dioxide and/or oxygen.

The well plate station 1 according to the example makes it possible to insert a well plate 5 in the apparatus in such a way that the position of the well plate can be changed in the horizontal plane (that is, in the X-Y directions) in relation to the microscope 2. The movement of the well plate 5 with respect to the microscope 2 makes it possible to image single wells on the well plate.

The tube microscope 2 according to the example, in turn, is very advantageous for phase contrast imaging. This structure makes it possible, for example, to move the objective in wider paths (particularly in the Z direction) than in conventional microscopes. This, in turn, makes it possible to move the objective more easily to a new position. In the example, the microscope 2 is connected to a digital camera 6, such as a CCD camera. The tube microscope 2 and the camera 6 are arranged to be moved in the vertical direction (that is, in the Z direction), wherein in an advantageous embodiment, the imaging system is focused by moving the combination of the microscope and the camera in the Z direction. The combination of the illuminator and the tube microscope (2, 3) can also be easily positioned in other angles to the object.

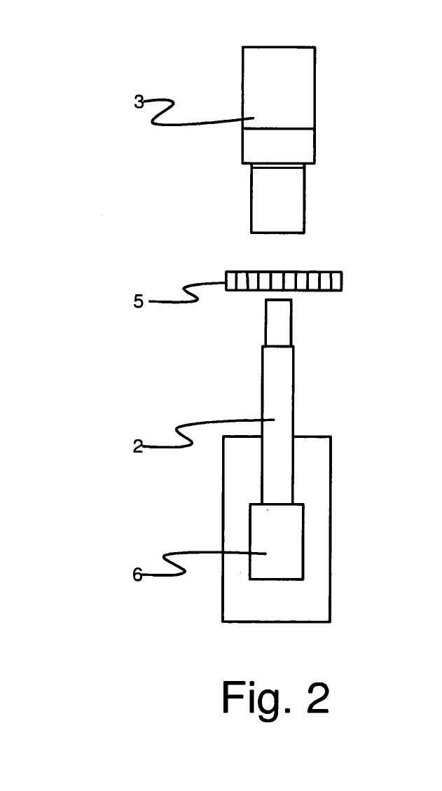

The illuminating device 3 is arranged to illuminate the object in the well plate 5 from the side opposite to the optical element 2 of the microscope, as can be seen from FIG. 2. In the example, the illuminating device 3 is above the well plate 5 and the optical element 2 of the microscope is underneath it. The light to be used for illumination can be either visible or invisible (e.g. IR or UV radiation) to human eyes, depending on the use. One embodiment of the structure of the illuminating device 3 will be described in more detail hereinbelow.

Furthermore, the apparatus comprises a control unit 7 and a data processing unit 8. The control unit 7 controls automatic imaging, wherein the desired imagings are performed at given points at fixed intervals. On the basis of various control parameters, the control unit directs e.g. the wells of the well plate 5 into the imaging area, the optics to the correct distance, and turns the lighting on and off at correct times. The illumination can be switched on accurately for the exposure time of the camera 6, when using a camera with an appropriate output signal.

The image information obtained from the camera 6 is transferred to a data processing unit 8 which may process the image material when necessary. For example, three-dimensional models can be created from the image material by using e.g. data of images taken from different parts of the object or images taken at different wavelengths. Furthermore, in one embodiment, the data processing unit 8 analyzes the image material.

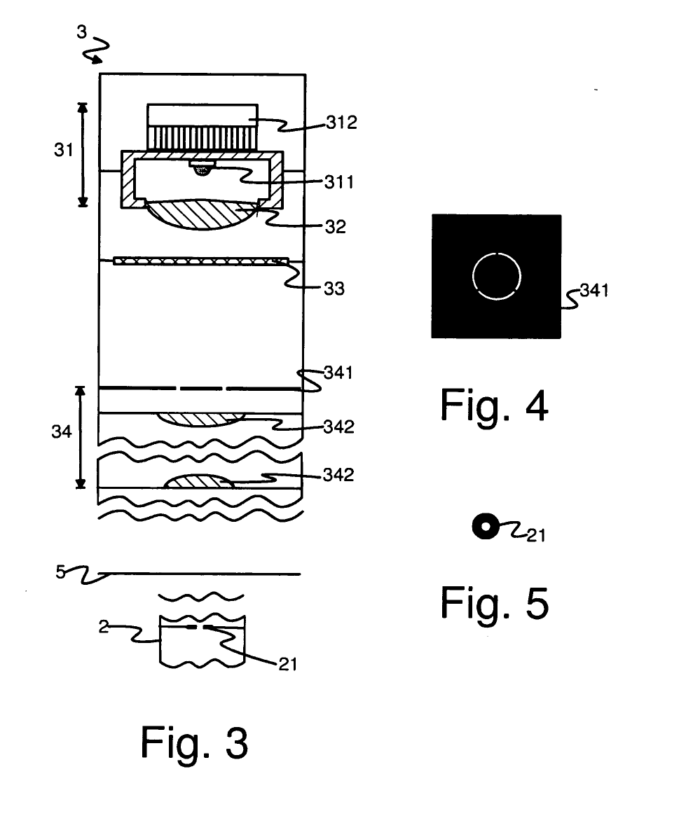

FIG. 3 shows one embodiment of the illuminating structure 3 in which LED illumination is used for phase contrast imaging. The illuminating structure 3 according to the example comprises a LED illuminator 31, a collimator 32, a diffusing plate 33, and a condenser structure 34. Furthermore, the image shows a phase ring 21 relating to the phase contrast objective of the microscope 2, for filtering off most of direct light (in FIG. 5, the phase ring 21 is seen in the vertical direction).

The LED illuminator 31 comprises e.g. a narrow-spectrum LED lamp 311 as well as the necessary power input and cooling structures 312. The LED lamp 311 may be a lamp emitting in a single wavelength range, or it is possible to use a LED functioning at several different wavelength ranges.

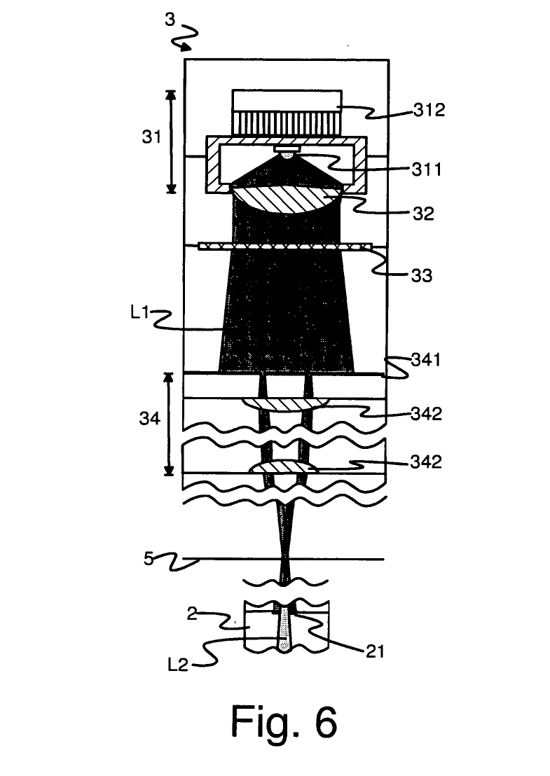

The condenser structure 34 comprises a condenser ring 341 and condenser lenses 342. The function of the condenser ring 341, shown in vertical direction in FIG. 4, is to “cut off” a given part of a light beam L1 to be led to the sample 5. In FIG. 6, the principle path of light in the apparatus according to the embodiment of FIG. 3 is illustrated by shadowing. Typically, an annular part is “cut” from the light beam L1 by the condenser ring 341. The condenser lenses 342 refract the light beams from the condenser ring 341 in such a way that they intercept at a given point, such as in the sample 5. The sample 5, in turn, may refract light, wherein the direction of the light beams is changed at least partly. By filtering off direct light, for example, with a phase ring 21, the light L2 refracted from the sample is left, wherein the contrast of the image is significantly better than when direct background light is used.

The LED achieves its stable functional mode significantly faster than Xenon, for example. Consequently, LED illumination can be turned on precisely for the time of the imaging, wherein the cells are not exposed to extra light. In other words, the energy of the radiation to which the cells are exposed can be controlled better. The time needed for imaging one sample is typically 15 to 30 ms but it depends on e.g. the camera, the sample, the power of the illuminator, as well as the optics. The turning on and off of the LED, in turn, takes place in microseconds, wherein the turning on and off of the illumination does not substantially increase the duration of the imaging. In one embodiment, the movement of the microscope and the camera to a new focusing position takes 50 to 100 ms (depending e.g. on the mechanical arrangements). Thus, by turning off the light for the time of the transfer it is possible to substantially reduce the exposure to light.

The light emitted by the LED is nearly monochromatic, wherein the light does not cause significant chromatic distortions. By means of the illumination system according to the invention, it is possible to obtain a sharp image without using bandpass filters. However, the invention makes it possible to use various filters, if necessary.

In one embodiment, it is possible to use different LEDs and thus to examine the effect of different wavelengths of light on cells. The change of the illuminating LED can be implemented in many ways, for example by changing the component or the illuminator. In some embodiments, however, it is more user friendly to change the wavelength of the light source without changing the components. In one embodiment, use is made of a LED component which can be set to emit at several wavelengths.

The above example presented one embodiment of the invention. The apparatus can be designed in a variety of ways in accordance with the spirit of the invention. For example, in some applications, it may be necessary to place the optical element 2 of the microscope and the camera 6 above the well plate 5 and the illumination 3 below the same. The relative movement of the well plate 5 and the microscope 2 is provided by arranging the well plate to be movable. In another embodiment of the invention, the relative movement of the well plate 5 and the microscope 2 is provided by moving the microscope. In yet another embodiment, the microscope 2 and the illumination system 3 are placed in a portal construction making the movement possible.

In the examples, the light production unit 31 of the illumination system 3 and the imaging device 6 are placed substantially close to the object 5 to be imaged. In one embodiment of the invention, the light emitting unit 31, i.e. the unit comprising the LED, is placed farther away from the object, and the light is led to the object by means of a suitable structure, such as an optical fibre structure. In another embodiment, in turn, the camera 6 is placed farther away from the object 6, and also in this case, the light is led from the object to the camera in a corresponding manner by means of a suitable structure, such as an optical fibre structure.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1-4. (canceled)

5. An automatic microscope apparatus intended to be used in phase contrast imaging of living cells, the apparatus comprising:
a sample plate station, in which a sample plate containing a sample to be examined can be fitted; and
a tube microscope comprising
an optical element,
an imaging means, and
an illumination arrangement configured to illuminate a sample and comprising an illuminating means comprising a light emitting diode with a narrow spectrum,
wherein the microscope is adjusted to be focused by moving the combination of the optical element and the imaging means in a Z direction.

6. The apparatus according to claim 5, wherein the illuminating means is arranged to illuminate during imaging only.

7. The apparatus according to claim 5, wherein the sample plate station is arranged to move the sample plate in relation to the optical element and the illumination arrangement.

8. The apparatus according to claim 6, wherein the sample plate station is arranged to move the sample plate in relation to the optical element and the illumination arrangement.

9. The apparatus according to claim 5, wherein the microscope is arranged to be movable in relation to the sample plate station.

10. The apparatus according to claim 6, wherein the microscope is arranged to be movable in relation to the sample plate station.

11. The apparatus according to claim 7, wherein the microscope is arranged to be movable in relation to the sample plate station.

12. The apparatus according to claim 8, wherein the microscope is arranged to be movable in relation to the sample plate station.
